(19) United States
(12) Patent Application Publication
(10) Pub. No.: US 2023/0302484 A1
(43) Pub. Date: Sep. 28, 2023

(54) VARIABLE FLOW AUTOMATIC CONFIGURATION FLUID APPLICATION DEVICE

(71) Applicant: Illinois Tool Works Inc., Glenview, IL (US)

(72) Inventors: Mel Steven Lessley, Villa Hills, KY (US); David Matthew Ogden, Cincinnati, OH (US)

(73) Assignee: Illinois Tool Works Inc., Glenview, IL (US)

(21) Appl. No.: 18/185,095

(22) Filed: Mar. 16, 2023

Related U.S. Application Data
(60) Provisional application No. 63/269,748, filed on Mar. 22, 2022.

(51) Int. Cl. B05C 5/02

(52) U.S. Cl. CPC B05C 5/0258; B05C 5/0241

(57) ABSTRACT

A fluid dispensing apparatus may be provided that includes a fluid reservoir configured to hold a liquid fluid. The fluid dispensing apparatus may include fluid output zones with at least one of the fluid output zones including plural fluid pumps. Each of the fluid pumps may have a flow rate at which the liquid fluid is pumped by the fluid pump. A slot die may also be provided that has a slot for each of the fluid output zones. The fluid dispensing apparatus may also include a relief valve mechanically connected to each of the fluid pumps, and a control device. The control device may be functionally connected to each relief valve, and the control device may be adapted to selectively instruct each valve to open or close to produce differing volume rates of fluid through each slot based on the relief valves selected.

### CROSS-REFERENCE TO RELATED APPLICATIONS

This application claims priority to U.S. Provisional Application No. 63/269,748 (filed Mar. 22, 2022), the entire disclosure of which is incorporated herein by reference.

### BACKGROUND

### Technical Field

The disclosure generally relates to strand coating systems and methods, and more particularly to systems, sub-systems, and methods for applying coatings (such as adhesives) to elongated strands and/or webs.

### State of the Art

Nonwoven fabrics include engineering fabrics that provide specific functions such as absorbency, liquid repellence, resilience, stretch, softness, strength, flame retardant protection, easy cleaning, cushioning, filtering, use as a bacterial barrier and sterility. In combination with other materials, nonwoven materials can provide a spectrum of products with diverse properties and can be used alone or as components of hygiene apparel, home furnishings, health care, engineering, industrial and consumer goods. Such products can include baby diapers, feminine hygiene pads, adult diapers, other absorbent hygiene products, or the like.

Generally adhesive coatings are applied in elongated strands and/or webs. The elongated strands/webs align with a nozzle from which an adhesive filament is dispensed. In addition, a plurality of elasticated strands/webs may be positioned on and bonded to the nonwoven materials to, for example, allow for flexibility fitting around an object or a person, where an adhesive application device may apply the glue to the strands/webs with either a contact nozzle or a non-contact nozzle. Typically the speed of the application is difficult to vary, preventing designs other than linear patterns.

In addition, manufacturing methods that utilize hot melt adhesives are often inefficient, and difficult to reproduce. Current fluid dispensing apparatuses have a flow rate of fluid applied to a chosen substrate that is static. Typically, fluid dispensing apparatuses are utilized for provided different patterned adhesives for different products. As a result, when a fluid dispensing apparatus is to be utilized for a new product, the apparatus must be adjusted, equipment added, eliminated, or modified, etc. to achieve the flow rates desired for the new product. Such a process not only takes significant time and resources, but additionally can result in significant space requirements being utilized for such changes.

### BRIEF DESCRIPTION

In one embodiment, a fluid dispensing apparatus may be provided that includes a fluid reservoir that holds a liquid fluid. The fluid dispensing apparatus may include fluid output zones with at least one of the fluid output zones including plural fluid pumps. Each of the fluid pumps may have a flow rate (same or different for the pumps) at which the liquid fluid is pumped by the fluid pump. A slot die may also be provided that has a slot for each of the fluid output zones. The fluid dispensing apparatus may also include a relief valve mechanically connected to each of the fluid pumps, and a control device. The control device may be functionally connected to each of the relief valves, and the control device may instruct each valve to selectively open or close to produce differing volume rates of fluid through each of the slots based on the relief valves selected.

In another embodiment, a fluid dispensing apparatus adapted to provide a controlled fluid flow rate may be provided. The fluid dispensing apparatus may include a fluid reservoir containing a liquid fluid, and at least two fluid output zones. At least one zone includes at least two fluid pumps, and each pump has a flow rate. The fluid dispensing apparatus may also include a controllable relief valve mechanically connected to each pump, and a control device. The control device may be functionally connected to each valve, and the control device can be adapted to selectively instruct each valve to open or close to produce differing volume rates of fluid based on the relief valves selected.

In another embodiment, a method of providing a controlled volume of a liquid to a substrate may be provided. The method may include providing a liquid reservoir, and providing a plurality of output zones. The method may also include providing a first pump and a second pump for at least one output zone of the plurality of output zones. The method may also include providing a first controllable relief valve for the first pump and a second controllable relief valve for the second pump, and providing a control device coupled to the first relief valve and the second relief valve. The method may also include selectively opening and closing the first relief valve and the second relief valve.

### BRIEF DESCRIPTION OF THE DRAWINGS

The inventive subject matter may be understood from reading the following description of non-limiting embodiments, with reference to the attached drawings, wherein below:

FIG. 1 illustrates a perspective illustration of an apparatus in accordance with one embodiment;

FIG. 2 illustrates an exploded perspective view of an apparatus in accordance with one embodiment;

FIG. 3 illustrates an exploded perspective view of an apparatus in accordance with one embodiment;

FIG. 4 illustrates a schematic diagram of an apparatus in accordance with one embodiment;

FIG. 5 illustrates a schematic diagram of an apparatus in accordance with one embodiment;

FIG. 6 illustrates a schematic block diagram of a control system in accordance with one embodiment; and

FIG. 7 illustrates and schematic block diagram of a method of dispensing fluid in accordance with one embodiment.

### DETAILED DESCRIPTION

Provided is a fluid dispensing apparatus that is typically utilized for dispensing adhesive. A fluid reservoir is provided along with plural fluid pumps for varying fluid output zones. The flow rate to a plenum resulting from each fluid pump can be electronically controlled by a corresponding relief valve that is mechanically connected to a corresponding fluid pump to meter flow from a group of fluid pumps to the plenum. Based on actuation of the relief valves, differing volume rates of fluid is dispensed in a corresponding nozzle. Because each fluid pump has a corresponding relief valve that controls the fluid output through each fluid pump, individual control of each pump is achieved, allowing variance of the fluid output of the fluid dispensing apparatus as desired without the need to change any equipment.

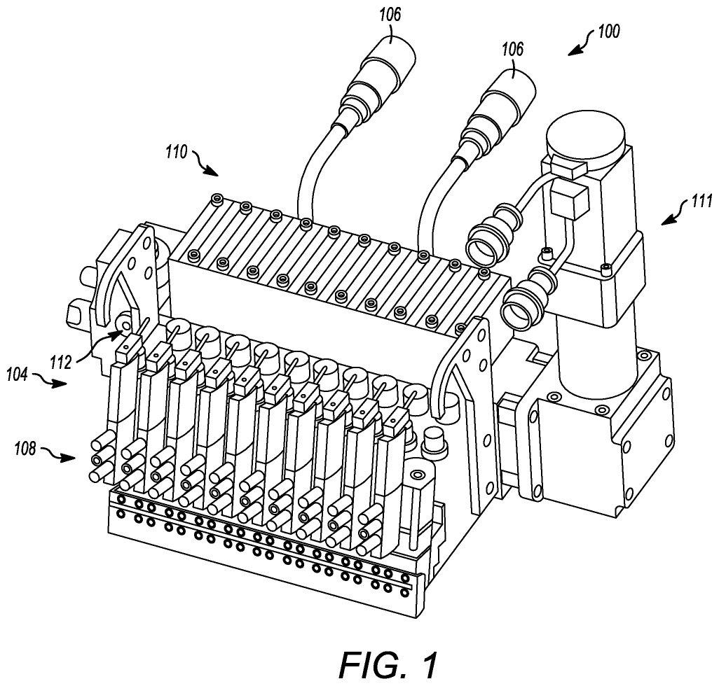

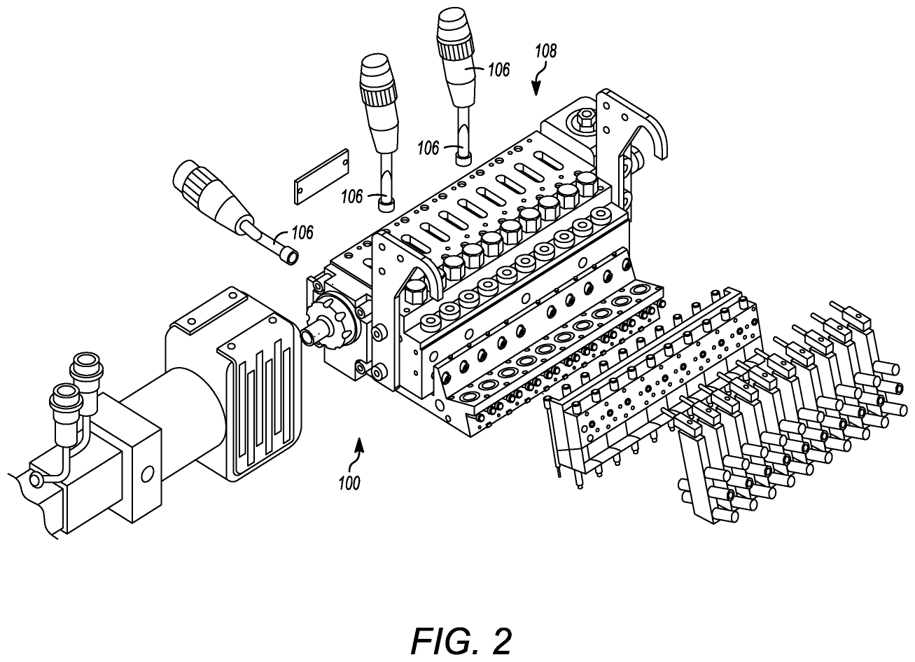

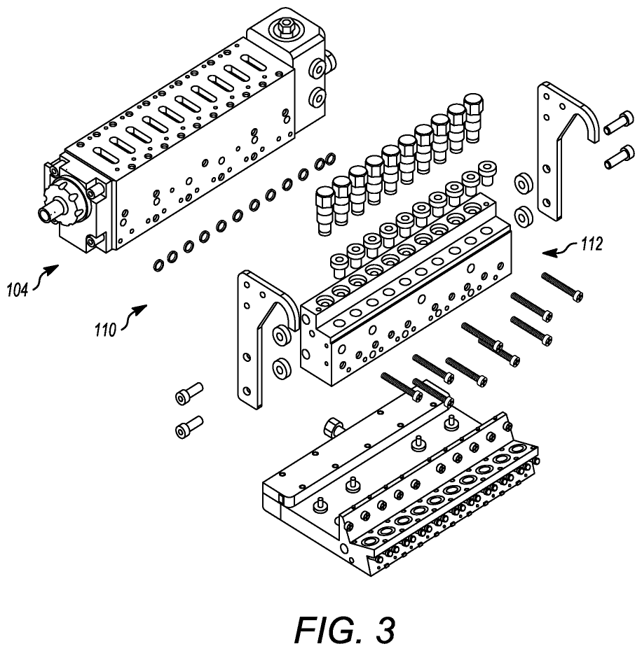

FIGS. 1-5 illustrate example embodiments of a liquid dispensing apparatus 100. In one example, the liquid dispensing apparatus 100 may apply a fluid, including a liquid adhesive to a strand or web of fiber or other substrate. The fluid may be an epoxy, glue, adhesive, paint, protective coating, lubricant, lotions, waxes, surfactants, inks, etc. or the like. In example embodiments, the liquid may be applied in a pattern on substrates, including substrates that form baby diapers, feminine hygiene pads, adult diapers, other absorbent hygiene products, or the like.

The liquid dispensing apparatus 100 receives fluid from a fluid reservoir 102 at a manifold 104. In another example, a module could replace the manifold, while in other examples a combination of a module and manifold is presented. The manifold includes a plurality of fluid inputs 106 and corresponding fluid outputs 108 with a fluid passageway therebetween. A plurality of pumps 110 are also provided where each fluid inlet 106 and corresponding fluid outlet 108 includes a corresponding fluid pump. Each of the plurality of pumps 110 controls the flow of fluid through the passageways of the corresponding fluid inlet 106 and fluid outlet 108 of the manifold 104. The number of fluid pumps 110 may vary based on the required patterns of a product. Thus, while in some embodiments five fluid pumps may be provided, in other example embodiments ten or more fluid pumps may be provided. In addition, each fluid pump 110 may also be replaceable. For example, a manifold 104 may have ten fluid passageways disposed therethrough, but only seven pumps 110 corresponding to seven of the passageways. In this manner, three of the passageways do not include a pump and fluid cannot be passed through the passageways. In one embodiment, the fluid substance is an adhesive that does not substantially flow as a result of gravity. In other embodiment, a fluid inlet 106, a fluid outlet 108, a fluid passageway, etc. may be blocked to prevent the fluid of fluid through the passageways that do not include a pump 110. By having the pumps be replaceable, the different patterns may be quickly and efficiently provided by merely replacing, adding, etc. a pump 110.

In one example, the plurality of pumps 110 may be controlled by an actuator 111. In one embodiment, the actuator may be a servo motor for controlling the operation of the pumps. In an example, the servo motor may include an in-line configuration, a ninety degree configuration, or the like.

Each of the fluid pumps 110 includes a relief valve 112 mechanically coupled thereto. In one example, the relief valve 112 may be a mechanical valve, pneumatic pressure relief valve, electrical relief valve, solenoid valve, or the like. Each relief valve 112 may be actuated to control, or meter, fluid from a group corresponding fluid pumps 110 to vary the speed at which the fluid flows to a fluid output zone 114. Alternative, a spray pattern to the fluid output zone may be varied. The relief valve 112 may provide control of the fluid flow at a rate a small as 0.05 cc per revolution. In one example, if an operator desires the flow of a first pump to be at 0.15 cc per revolution while a second pump flows at 0.4 cc per revolution, the relief valve may provide such accuracy. By providing the relief valve 112 that can vary the rate of flow to each fluid output zone 114, when a new product with a different pattern is provided, an operator only needs to adjust the flow rate to the fluid output zone 114 by actuating each individual relief valve 112 that dispenses fluid to the fluid output zone 114 without having to reconfigure the entire fluid dispensing apparatus. Consequently, time, floor space, etc. is saved while increasing manufacturing efficiencies.

In one example, the fluid output zones 114 comprise a plenum. The plenum may provide a pattern for dispensing the fluid onto a substrate. Each fluid output zone 114 includes at least one corresponding fluid pump 110 having a discrete volumetric fluid output rate. A fluid output zone 114 may also include more than one pump 110 associated with the fluid output zone 114. The number of different fluid output zones 114 and the number of pumps 110 corresponding to each fluid output zone 114 are determined based on the pattern desired to be provided on a substrate. Each fluid output zone 114 includes a corresponding fluid outlet 108. In one example, each fluid outlet may be a slot die. Alternatively, the fluid outlet may include spray nozzles, strand or web outputs, bead output, ports, or the like. As a result of selecting the number of fluid pumps 110, the location of the pumps 110, and the flow rate through each relief valve 112, an adhesive 116 is deposited on a substrate, or fabric that includes different consistencies at the different fluid output zones 114.

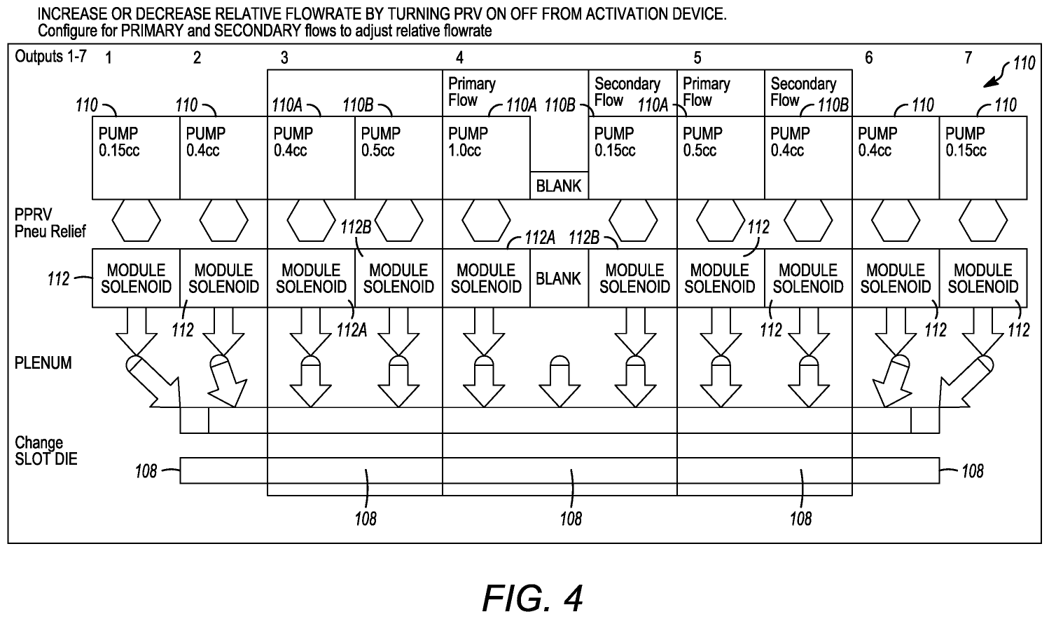

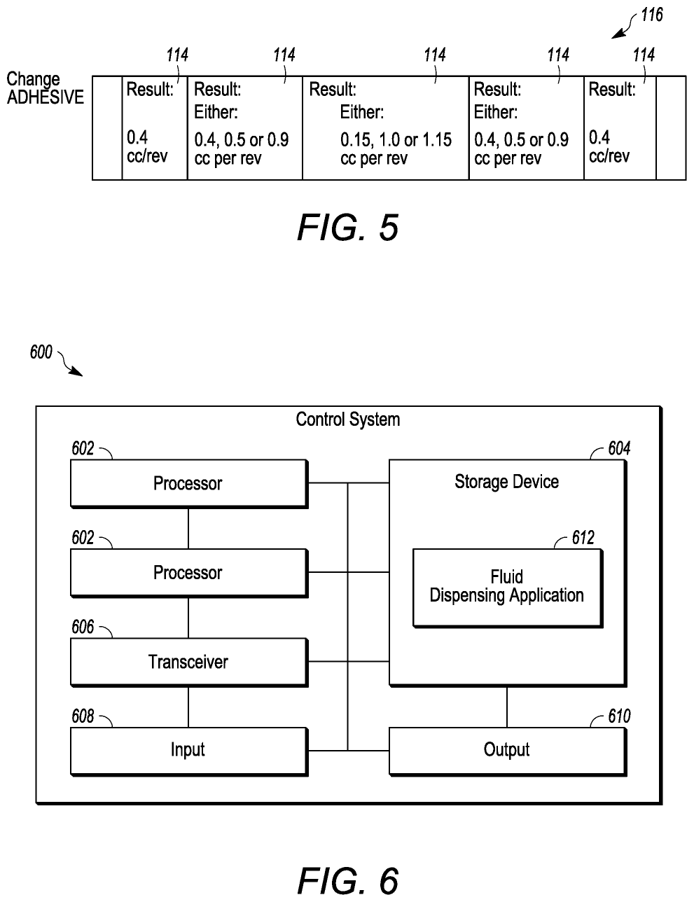

In one example, each fluid output zone may have a single fluid pump 110 and corresponding relief valve 112 associated therewith (e.g. FIG. 4) such that the consistency of the adhesive 116 in each fluid output zone 114 may differ. As a result, differing volume rates of fluid may be applied in each fluid output zone 114 (e.g. FIG. 5) based on the actuation of the relief valves 112. In one example, the pumps, and/or relief valves may be spaced from one another at the same, or differing distances. In an example, the width may vary from fifty millimeters (50 mm) to three hundred millimeters (300 mm). In other embodiments that spacing may be less than 50 mm or greater than 300 mm.

In one example, if the consistency of the adhesive at a specific fluid output zone 114 is to be varied, the relief valve 112 is actuated to meter the fluid forming the adhesive at the fluid output zone at a different rate. Alternatively, plural fluid pumps 110 and corresponding relief valves 112 can be provided for a single fluid output zone 114, and the consistency of the adhesive 116 in the fluid output zone may be varied by simply turning on and off different relief valves 112 associated with the fluid output zone 114. For example, a single fluid output zone 114 may include a first pump 110A and first relief valve 112A that deposits the adhesive in the fluid output zone 114 at 1 cc/rev when actuated, and a second pump 110B and second relief valve 112B that deposits the adhesive in the fluid output zone 114 at 0.15 cc/rev. (e.g. FIG. 5). In this manner, a controller may actuate the first relief valve 112A and second relief valve 112B such that i.) only the first relief valve 112A deposits adhesive 116 at the fluid output zone 114 to produce a discreate volume rate of 1 cc/rev; ii.) only the second relief valve 112B deposits adhesive 116 at the fluid output zone 114 to produce a discreate volume rate of 0.15 cc/rev; iii.) both the first relief valve 112A and the second relief valve 112B deposit adhesive 116 at the fluid output zone 114 to produce a discreate volume rate of 1.15 cc/rev; or iv.) neither the first relief valve 112A or the second relief valve 112B deposit adhesive. In this manner, by selecting the relief valves (e.g. 112A and/or 112B) to actuate that produce different rates of flow, differing volume rates of fluid can be produced in a fluid output zone 114 based on the selected relief valves 112A, 112B. Thus, the consistency of the adhesive in a fluid output zone 114 may be varied without changing equipment, or even varying individual flow rates of individual relief valves. While in this example only two pumps with respective first relief valve 112A and second relief valve 112B are described, in other examples, three pumps with three relief valves, four pumps with four relief valves, or more may be provided such that numerous combination and flow rates to an individual fluid output zone 114 may be achieved. For example, with four different pumps each having a different flow rate, and having four corresponding relief valves, up to twelve different combinations of flow rate may be provided to a single fluid output zone 114 by controlling individual relief valves without a need to change out any pumps or equipment.

FIG. 6 illustrates a control system 600 that may electronically couple with the fluid dispensing apparatus, and/or be part of a fluid dispensing apparatus. In one example, the fluid dispensing apparatus is the fluid dispensing apparatus as illustrated in FIGS. 1-5.

The control system 600 may include one or more processors 602 that can execute instructions, including program instructions, application instructions, or the like. The control system may also include at least one storage device 604 that may be in communication with the one or more processors 602. The at least one storage device 604 may be a memory, store instructions to be executed by the one or more processors, etc. The control system may also include a transceiver 606 for receiving and transmitting signals, data, information, or the like. The control system 600 may also include an input 608 such as a keyboard, mouse, touch screen, microphone, etc. The control system 600 may similarly include an output 610 such as a display, speakers, etc. In some examples, the input 608 and output 610 may be the same device, such as a screen.

The control system 600 may also include a fluid dispensing application 612. The fluid dispensing application 612 may provide instructions so that the one or more processors can determine a pattern or an amount of adhesive desired to be deposited on a substrate at specific locations. In example embodiments, the substrate may be a fabric, diaper, feminine hygiene product, etc. The fluid dispensing application 612 may include, or be able to access plural product templates that include the consistency of an adhesive that is to be deposited on the substrate. The templates may be obtained via the transceiver, 606, uploaded, downloaded, created, saved, etc. In each instance, the amount of adhesive for each individual fluid output zone may be pre-determined prior to application of the adhesive on the substrate. Then, the fluid dispensing application 612 may vary the flow, or amount of adhesive provided to each fluid output zone depending on the amount pre-determined.

In one example, more than one pump is utilized to provide adhesive to a particular fluid output zone, and the relief valve corresponding to each pump may be actuated to add, subtract, or otherwise vary the amount of adhesive flowing to the fluid output zone. In this manner, the fluid dispensing application may make determination related to the amount of adhesive required for each fluid output zone for a given product, and actuate various relief valves to cause the amount of adhesive desired to be applied to each fluid output zone accordingly.

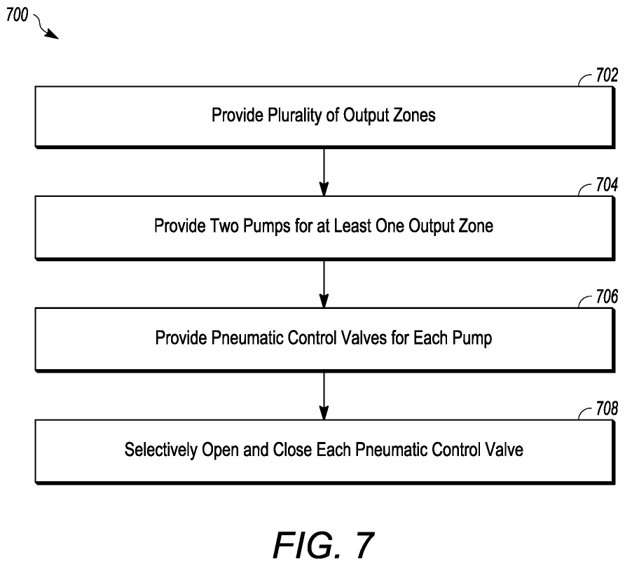

FIG. 7 illustrates a block flow diagram of a method of dispensing a fluid on a substrate 700. The fluid in one example can be an adhesive. In one example, the method may be accomplished or performed utilizing any of the systems, assemblies, devices, etc. previously described herein.

At 702, a plurality of fluid output zones may be provided. In one example, a fluid output zone may include a fluid outlet through which a discreate amount of fluid may flow. In one example, an amount of fluid for a spray pattern may be provided. In another example, the fluid output zone may comprise a portion of a plenum.

At 704, at least two pumps are provided for at least one fluid output zone. In one example, a first pump is provided that controls the flow of fluid of a first volume of fluid, while a second pump is provided that controls the flow of fluid of a second volume of fluid that is different than the first volume of fluid. In this manner, one or more processors may control the amount of fluid flowing through the outlet to include the first volume of fluid, the second volume of fluid, or a combination of the first volume of fluid with the third volume of fluid. In this manner the amount of fluid provided may by varied by merely actuating a pump instead of changing out portions of the system. In another example, the first pump and second pump may provide flow of fluid at the same flow rate, or volume, providing two different pumps that can provide the same flow rate, or alternatively a combination of pumps that can provide double the flow rate of a single pump. Still, the flow rate may be added to, subtracted from, or otherwise varied by utilizing the two pumps for the single fluid output zone.

At 706, control valves are provided for each pump. In one example, a pneumatic pressure control valve may be provided, and in other examples solenoid control valves, electrical control valves, hydraulic control valves, or the like may be utilized. The control valve may be actuated to provide the discreate amount of fluid desired for a fluid output zone.

At 708, a control device coupled to each pneumatic control valve may selectively open and close each control valve. The control device may control the control valves as a result of an operator input, a timing device in a program, a program, based on sensor information including a sensor that detects the location of a substrate, fabric, or the like. As a result, a liquid, such as an adhesive, may be pumped through the selectivity opened valves onto the substrate, fabric, or the like. In one example, a slot die having a slot may be utilized to provide a pattern on the substrate with the fluid being pumped through the slot die.

In one or more example embodiments, a fluid dispensing apparatus may be provided that includes a fluid reservoir configured to hold a liquid fluid. The fluid dispensing apparatus may include fluid output zones with at least one of the fluid output zones including plural fluid pumps. Each of the fluid pumps may have a flow rate at which the liquid fluid is pumped by the fluid pump. A slot die may also be provided that has a slot for each of the fluid output zones. The fluid dispensing apparatus may also include a relief valve mechanically connected to each of the fluid pumps, and a control device. The control device may be functionally connected to each relief valve, and the control device may be adapted to instruct each valve to open or close to produce differing volume rates of fluid through each slot based on the selected relief valves.

Optionally, the liquid fluid may be an adhesive. In one aspect, the fluid output zone can comprise a plenum. In another aspect, the relief valve may be a pneumatic relief valve. In one example, at least one of the fluid output zones includes a first fluid pump that has a first flow rate, and a second fluid pump that has a second flow rate. Optionally, the first flow rate is different than the second flow rate. Alternatively, the first fluid pump may operate while the second fluid pump operates. In another example, the fluid dispensing apparatus may also include a manifold for dispensing the fluid from the fluid reservoir to each of the output zones.

In one or more example embodiments, a fluid dispensing apparatus adapted to provide a controlled fluid flow rate may be provided. The fluid dispensing apparatus may include a fluid reservoir containing a liquid fluid, and at least two fluid output zones. At least one zone includes at least two fluid pumps, and each pump has a flow rate. The fluid dispensing apparatus may also include a controllable relief valve mechanically connected to each pump, and a control device. The control device may be functionally connected to each valve, and the control device can be adapted to instruct each valve to open or close to produce differing volume rates of fluid based on the relief valves selected.

Optionally, the fluid dispensing device includes a slot die having a slot for each output zone. In one aspect, the control device is configured to produce the differing volume rates for each slot for each output zone. In another aspect, the liquid fluid is an adhesive. In yet another aspect, the relief valve is at least one of a pneumatic relief valve or an electric relief valve.

Optionally, the at least one of the fluid output zones includes a first fluid pump that has a first flow rate, and a second fluid pump that has a second flow rate. In one aspect, the first flow rate is different than the second flow rate. In another aspect, the first fluid pump is configured to operate while the second fluid pump operates. In one example, the fluid dispensing device also includes a manifold for dispensing the fluid from the fluid reservoir to each of the output zones.

In one or more example embodiments, a method of providing a controlled volume of a liquid to a substrate may be provided. The method may include providing a liquid reservoir, and providing a plurality of output zones. The method may also include providing a first pump and a second pump for at least one output zone of the plurality of output zones. The method may also include providing a first controllable relief valve for the first pump and a second controllable relief valve for the second pump, and providing a control device coupled to the first relief valve and the second relief valve. The method may also include selectively opening and closing the first relief valve and the second relief valve.

Optionally, the method also includes pumping the liquid through a selectively opened first relief valve and second relief valve through a slot of a slot die onto to a substrate. In one aspect, the method may also include varying an amount of fluid flowing to the output zone by selectively opening and closing the first relief valve and the second relief valve.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A fluid dispensing apparatus comprising:
fluid pumps each configured to have a flow rate at which a fluid is pumped by the fluid pump;
a relief valve mechanically connected to each of the fluid pumps; and
a control device functionally connected to each relief valve, wherein the control device is adapted to selectively instruct each relief valve to open or close to produce differing volume rates of fluid through a fluid output for each of the fluid pumps based on the relief valves selected.

2. The fluid dispensing apparatus of claim 1, wherein the fluid is an adhesive.

3. The fluid dispensing apparatus of claim 1, wherein the fluid output is a slot, and the fluid dispensing apparatus further comprises a plenum for receiving the liquid from the plenum.

4. The fluid dispensing apparatus of claim 1, wherein the relief valve is a pneumatic pressure relief valve.

5. The fluid dispensing apparatus of claim 1, wherein the fluid output includes at least one fluid output zone that includes a first fluid pump of the fluid pumps that has a first flow rate, and a second fluid pump of the fluid pumps that has a second flow rate.

6. The fluid dispensing apparatus of claim 5, wherein the first flow rate is different than the second flow rate.

7. The fluid dispensing apparatus of claim 6, wherein the first fluid pump is configured to operate while the second fluid pump operates.

8. The fluid dispensing apparatus of claim 5, further comprising a manifold for dispensing the fluid from a fluid reservoir to the at least one fluid output zone.

9. A fluid dispensing apparatus adapted to provide a controlled fluid flow rate, the apparatus comprising:
a fluid reservoir configured to contain a fluid;
at least two fluid output zones that receive the fluid from at least two fluid pumps at a flow rate of each of the fluid pumps;
a controllable relief valve mechanically connected to each of the fluid pumps;
a control device functionally connected to each controllable relief valve, wherein the control device is adapted to selectively instruct each controllable relief valve to open or close to produce differing volume rates of fluid based on the controllable relief valves selected.

10. The fluid dispensing apparatus of claim 9, further comprising a slot die having a slot for each fluid output zone of the at least two fluid output zones.

11. The fluid dispensing apparatus of claim 10, wherein the control device is configured to produce the differing volume rates for each slot for each output zone.

12. The fluid dispensing apparatus of claim 9, wherein the fluid is an adhesive.

13. The fluid dispensing apparatus of claim 9, wherein the relief valve is at least one of a pneumatic pressure relief valve or an electrical relief valve.

14. The fluid dispensing apparatus of claim 9, wherein the at least one of the fluid output zones includes a first fluid pump of the at least two fluid pumps having a first flow rate and a second fluid pump of the at least two fluid pumps having a second flow rate.

15. The fluid dispensing apparatus of claim 14, wherein the first flow rate is different than the second flow rate.

16. The fluid dispensing apparatus of claim 15, wherein the first fluid pump is configured to operate while the second fluid pump operates.

17. The fluid dispensing apparatus of claim 9, further comprising a manifold for dispensing the fluid from the fluid reservoir to each of the at least two fluid output zones.

18. A method of providing a controlled volume of a liquid to a substrate, the method comprising:
selectively opening and closing a first relief valve of a first pump and a second relief valve of a second pump to produce differing volume rates of fluid to one of a plurality of output zones.

19. The method of claim 18 further comprising pumping the liquid through the selectively opened first relief valve and the selectively opened second relief valve through a slot of a slot die onto to a substrate.

20. The method of claim 18, further comprising, varying an amount of fluid flowing to the output zone by selectively opening and closing the first relief valve and the second relief valve.
